(19) United States
(12) Patent Application Publication
(10) Pub. No.: US 2011/0313756 A1
(43) Pub. Date: Dec. 22, 2011

(54) Text sizer (TM)

(76) Inventor: Robert A. Connor, Minneapolis, MN (US)

(21) Appl. No.: 12/803,161

(22) Filed: Jun. 21, 2010

(51) Int. Cl. G06F 17/27

(52) U.S. Cl. 704/9

(57) ABSTRACT

This invention called Text Sizer ™ is an innovative method and system for changing the length of a body of text. It may be embodied in the following steps. First, a first text segment may be selected in a body of text. Second, alternative text segments are automatically identified, wherein each alternative text segment may be substituted for the first text segment in the body of text without causing a grammatical error. Third, a second text segment with a length that is different than the length of the first text segment is selected from among the alternative text segments. Finally, the second text segment is substituted for the first text segment in the body of text. This method has many applications. One might wish to reduce the length of a body of text so that it fits within a constrained space. For example, a report or proposal may have page limits. Alternatively, one might wish to expand the length of selected portion of a body of text. For example, one might wish to elaborate or include additional information on topics covered in a particular segment of text. Text Sizer ™ provides users with this capability.

### CROSS-REFERENCE TO RELATED APPLICATIONS

Not Applicable

### FEDERALLY SPONSORED RESEARCH

Not Applicable

### SEQUENCE LISTING OR PROGRAM Not Applicable

### BACKGROUND

1. Field of Invention

This invention relates to text-processing methods.

There are many potential applications for a text processing method and system that can enable a user to change the length of one or more selected text segments in a body of text. For example, one might wish to decrease the length of one or more text segments so that the body of text can fit within a constrained space such as: a report or proposal with a maximum page limit; a print media page, column or classified ad; the top screen viewing portion of a website home page; or even a 140-character Twitter® line with special abbreviations. On the other hand, one might wish to increase the length of one or more text segments: to provide further elaboration or additional information on the topic that is covered by that segment; to expand the body of text so that it completely fills a designated space such as the top screen viewing portion of a website homepage; or to expand a 140-character Twitter® line with abbreviations into a full paragraph written in unabbreviated natural language. The innovative method and system disclosed herein, called Text Sizer ™, can give users this capability.

2. Review of the Prior Art

There are many text-modifying methods and applications in the prior art. In order to more efficiently review and contrast the relevant methods in the prior art, we have categorized them into ten general categories: (1) methods that change text to correct errors; (2) methods that change text to reduce overuse of certain words; (3) methods that change text style; (4) methods that change text vocabulary level; (5) methods that formalize text structure; (6) methods that change text for search engine optimization; (7) methods that create phrase variation for expanded search; (8) methods that exchange content across different documents; (9) methods that create document summaries; and (10) methods that condense text to create a tagged string. We now discuss each of these ten categories, including examples of each.

1. Methods That Change Text to Correct Errors

The prior art includes methods that modify text in order to correct spelling errors, grammatical errors, and other types of errors. These methods are very useful for some applications. However, they do not provide a method to decrease or increase the length of a body of text by selecting a segment in that text, automatically identifying alternative segments that are shorter or longer (depending on whether one wants to shrink or expand the body of text), and substituting one alternative segment that is selected at least partially based on length. Examples in the prior art that appear to disclose methods for modifying text to correct errors include: U.S. Pat. No. 4,674,065 (Lange et al. 1987, “System For Detecting and Correcting Contextual Errors in a Text Processing System”) and U.S. pat. No. 7,640,158 (Detlef et al. 2009, “Automatic Detection and Application of Editing Patterns in Draft Documents”); and U.S. Patent Applications 20040107089 (Gross et al. 2004, “Email Text Checker System and Method”) and 20090006950 (Gross et al. 2009, “Document Distribution Control System and Method Based on Content”).

2. Methods That Change Text to Reduce Overuse of Certain Words

The prior art includes at least one method to change text in order to reduce overuse of certain words. This method is useful for reducing redundancy and enhancing textual style. However, it does not disclose a method to decrease or increase the length of a body of text by selecting a segment in that text, automatically identifying alternative segments that are shorter or longer (depending on whether one wants to shrink or expand the body of text), and substituting one alternative segment at least partially based on length. An example of such a method in the prior art is U.S. Pat. No. 5,742,834 (Kobayashi 1998, “Document Processing Apparatus Using a Synonym Dictionary”).

3. Methods That Change Text Style

The prior art also includes some methods that change the style of a body of text. Several of these methods involve replacing phrases in the body of text (that are consistent with a first style) with phases with similar meaning (that are consistent with a second style). For example, one method is explicitly targeted to replace “trite” expressions. The ability to change the style of a body of text can be useful for preparing similar material for different audiences and purposes. However, these methods do not provide a way to decrease or increase the length of a body of text by selecting a segment in that text, automatically identifying alternative segments that are shorter or longer (depending on whether one wants to shrink or expand the body of text), and substituting one alternative segment at least partially based on length. Examples in the prior art that appear to disclose methods that change text style include U.S. Pat. No. 4,773,039 (Zamora 1988, “Information Processing System for Compaction and Replacement of Phrases”), U.S. Pat. No. 7,113,943 (Bradford et al. 2006, “Method for Document Comparison and Selection”), U.S. Pat. No. 7,472,343 (Vasey 2008, “Systems, Methods and Computer Programs for Analysis, Clarification, Reporting on and Generation of Master Documents for Use in Automated Document Generation”), U.S. Pat. No. 7,599,899 (Rehberg et al. 2009, “Report Construction Method Applying Writing Style and Prose Style to Information of User Interest”), and U.S. Pat. No. 7,627,562 (Kacmarcik et al. 2009, “Obfuscating Document Stylometry”).

4. Methods That Change Text Vocabulary Level

In the prior art there are methods to modify text in order to change the vocabulary level of the words used in the text. For example, such methods can substitute words associated with a lower grade level for words used in a body of text that are associated with a higher grade level. Such methods can be very useful for certain applications. However, these methods do not decrease or increase the length of a body of text by selecting a segment in that text, automatically identifying alternative segments that are shorter or longer (depending on whether one wants to shrink or expand the body of text), and substituting one alternative segment at least partially based on length. Examples in the prior art that appear to change the vocabulary level of a body of text include U.S. Pat. No. 4,456,973 (Carlgren et al. 1984, “Automatic Text Grade Level Analyzer for a Text Processing System”); U.S. Pat. No. 5,359,514 (Manthuruthil et al. 1994, “Method and Apparatus for Facilitating Comprehension of On-Line Documents”); and U.S. pat. No. 7,386,453 (Polanyi et al. 2008, “Dynamically Changing the Levels of Reading Assistance and Instruction to Support the Needs of Different Individuals”).

5. Methods That Formalize Text Structure

The prior art includes methods that formalize text structure, especially methods that convert unstructured natural language into documents with a particular structure or term set. The methods in this category are useful for some applications. However, they do not provide a method to decrease or increase the length of a body of text by selecting a segment in that text, automatically identifying alternative segments that are shorter or longer (depending on whether one wants to shrink or expand the body of text), and substituting one alternative segment at least partially based on length. One example in the prior art of a method that appears to change text structure is U.S. Patent Application 20070100823 (Inmon 2007, “Techniques for Manipulating Unstructured Data Using Synonyms and Alternate Spellings Prior to Recasting as Structured Data”).

6. Methods That Change Text for Search Engine Optimization

The prior art also includes methods that modify text on a website in an effort to improve the ranking of that website by search engines for particular terms. Such methods have a relatively targeted application. They do not provide a way method to decrease or increase the length of a body of text by selecting a segment in that text, automatically identifying alternative segments that are shorter or longer (depending on whether one wants to shrink or expand the body of text), and substituting one alternative segment at least partially based on length. One example in the prior art that appears to be at least one method that modifies text to try to improve search engine ranking is U.S. Patent Application 20090313233 (Hanazawa 2009, “Inspiration Support Apparatus Inspiration Support Method and Inspiration Support Program”).

7. Methods That Create Phrase Variation for Expanded Search

The prior art includes methods to create variation in text segments, especially search queries, in order to expand the results of a search based on that text segment. These methods are useful for enhanced search. However, they are not useful for changing the length of a body of text. One example in the prior art that appears to disclose a method that creates variation in text segments to enhance search is U.S. Pat. No. 5,469,355 (Tsuzuki 1995, “Near-Synonym Generating Method”).

8. Methods That Exchange Content Across Different Documents

The prior art also includes methods that modify or exchange content across two or more different bodies of text. Although these methods have useful applications, they do not provide a method to change the length of a single body of text. One example in the prior art that appears to disclose a method that exchanges content across different bodies of text is U.S. Patent Application 20090217159 (Dexter et al. 2009, “Systems and Methods of Performing a Text Replacement Within Multiple Documents”).

9. Methods That Create Document Summaries

There are several methods in the prior art that create document summaries. This is a useful function. However, a summary only provides an overview of the content in a body of text. It does not provide a shorter, but complete, version of all the information in that document. Further, summary methods only function in one direction when it comes to changing length. They cannot create an expanded version of a body of text. Moreover, methods in this category do not provide a method to either decrease or increase the length of a body of text by selecting a segment in that text, automatically identifying alternative segments that are shorter or longer (depending on whether one wants to shrink or expand the body of text), and substituting one alternative segment at least partially based on length. Examples in the prior art that appear to disclose methods to create document summaries include U.S. Pat. No. 7,292,972 (Lin et al. 2007, “System and Method for Combining Text Summarizations”); U.S. Pat. No. 7,447,626 (Chaney et al. 2008, “Method and Apparatus for Generating a Language Independent Document Abstract”); U.S. Pat. No. 7,587,309 (Rohrs et al. 2009, “System and Method for Providing Text Summarization for Use in Web-Based Content”); U.S. Pat. No. 7,607,083 (Gong et al. 2009, “Test Summarization Using Relevance Measures and Latent Semantic Analysis”); and U.S. Pat. No. 7,627,590 (Boguraev et al. 2009, “System and Method for Dynamically Presenting a Summary of Content Associated with a Document”).

10. Methods That Condense Text to Create a Tagged String

The prior art includes at least one method to modify text in order to create a tagged string. Such tagged strings can be useful for softkey applications on Integrated Services Digital Network (ISDN) telephone sets. However, they do not provide a method to decrease or increase the length of a body of text by selecting a segment in that text, automatically identifying alternative segments that are shorter or longer (depending on whether one wants to shrink or expand the body of text), and substituting one alternative segment at least partially based on length. An example in the prior art that appears to disclose a method to create a tagged string is U.S. Pat. No. 5,420,973 (Dagdeviren 1995, “Abridgment of Text-Based Display Information”).

### SUMMARY OF THIS INVENTION

This invention, called Text Sizer ™, is an innovative method and system for changing the length of a body of text. It may be embodied in the following four steps. First, a first text segment is selected in a body of text. Second, one or more alternative text segments are automatically identified, wherein each of these alternative text segments may be substituted for the first text segment in the body of text without causing a grammatical error. Third, a second text segment, with a length that is different than the length of the first text segment, is selected from among the alternative text segments. Finally, the second text segment is substituted for the first text segment in the body of text in order to decrease or increase the length of the body of text. None of the methods in the prior art appear to offer users such capability to decrease or increase the length of a body of text in this manner.

There are many useful applications for this method and system. One might wish to reduce the length of a body of text so that it fits within a constrained space. For example, a report or proposal may have page limits. As another example, one might wish to fit an entire article into the top screen viewing portion of a website home page. As an extreme example, one might wish to condense a portion of a body of text into a 140-Twitter ™ line. Alternatively, one might wish to expand the length of a selected portion of a body of text. For example, one might wish to elaborate or include additional information on topics covered in a particular segment of text. As another example, one might wish to expand a body of text so that it completely fills a given space such as the top screen viewing portion of a website homepage. One might even wish to expand an abbreviated Twitter ™ line into a paragraph written in unabbreviated natural language. Text Sizer ™ can give users this capability.

### DETAILED DESCRIPTION OF THE FIGURE

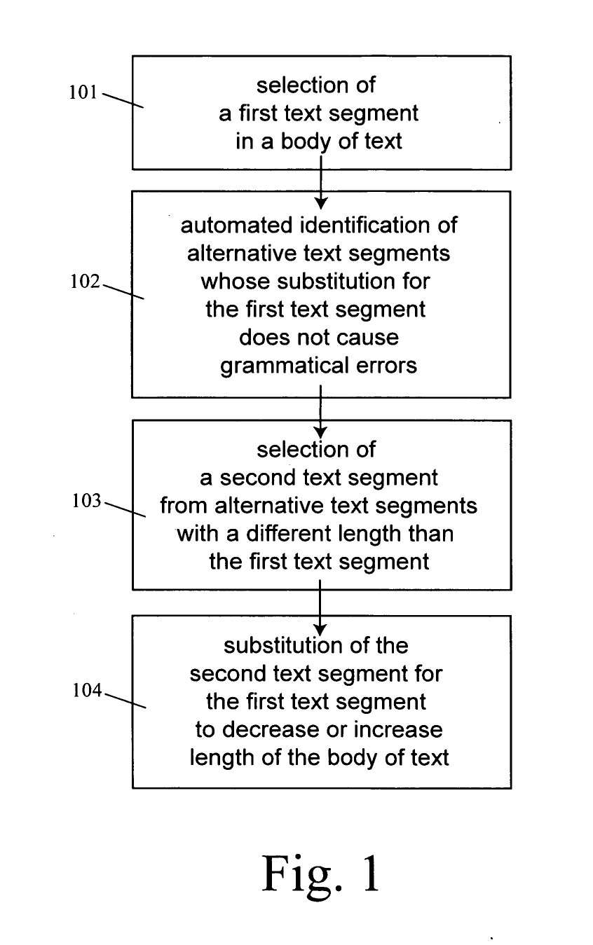

FIG. 1 shows one possible embodiment of this method and system for changing the length of a body of text. However, there are other possible embodiments of this method and this figure does not limit the full generalizability of the claims. FIG. 1 shows a four-step embodiment of this method and system to change the length of a body of text.

The first step in this embodiment of the method is step 101 as shown at the top of FIG. 1. Step 101 is the selection of a first text segment, within a body of text. In an example, this selection may be done by a user. For example, the user may highlight a section of text using a cursor that the user moves by moving a computer mouse. In another example, this selection may be done by a user who highlights a section of text by moving their finger across a touch screen. In another example, selection of a first text segment may be done in an automated manner. One example of automatic selection of a first text segment is selection of a first text segment by a computer program that searches for text segments in the body of text that are also found in a database of sets of synonymous text segments. This database may be constructed such that any text segment within a set may be substituted in a body of text for any other text segment in that set, without creating a significant change in meaning or grammatical errors in that body of text.

The second step in this embodiment of the method, step 102, is the identification of one or more alternative text segments. Each alternative text segment may be substituted for the first text segment in the body of text without causing a grammatical error. In an example, only alternative text segments that do not significantly change the meaning of the body of text when substituted for the first text segment may be included among the alternative text segments that are identified. For example, this could be done by using a database like the one mentioned above, wherein this database contains sets of synonymous text segments in which any text segment may be substituted for any other text segment in that set without creating a significant change in meaning or grammatical errors in a body of text. In another example, alternative text segments that change the meaning of the body of text when substituted for the first text segment may be allowed among the alternative text segments. In the latter case, substitution of alternative text segments, especially longer ones, may actually change or add content in the body of text. In an example, there may be a mechanism for the user to indicate whether they do, or do not, want to allow alternative text segments that change the meaning of the body of text. Identification of alternative text segments is then guided by this user indication.

In an example, the identification of alternative text segments may be done using a database comprised of sets of substitutable text segments. In another example, identification of alternative text segments may be done using common word patterns or associations that are discovered through analysis of a large collection of text-based sources. In another example, identification of alternative text segments may be done using a natural language generator. In an example, identification of alternative text segments may be done for the first text segment as a whole. In another example, identification of alternative text segments may be done by parsing the first text segment into phrases, identifying possible alternatives for each of the phrases individually, and then combining the alternative phrases into various alternatives for the first text segment as a whole. “Second-order substitution” may be defined as substitution within a text segment that is itself already a substitution into the body of text. In an example, second-order text segment substitution may be allowed. In another example, second-order text substitution may not be allowed.

In an example, the length of the first text segment or the length of the body of text may be defined as the number of character spaces in the text segment or the body of text. In other examples, length may be defined as the number of characters, words, phrases, sentences, paragraphs, or pages within a text segment or body of text. In an example, the user may indicate that they wish to decrease the length of the body of text and alternative text segments that are shorter than the first text segment would be identified in order to decrease the length of the body of text. In another example, the user may indicate that they wish to increase the length of the body of text and alternative text segments that are longer than the first text segment would be identified in order to increase the length of the body of text.

The third step in this embodiment of the method, step 103, involves the selection of a second text segment from among the alternative text segments, wherein the second text segment has a different length than the first text segment. For example, if the user wishes to decrease the length of the body of text, then a second text segment that is shorter than the first text segment would be selected. As an alternative example, if the user wishes to increase the length of the body of text, then a second text segment that is longer than the first text segment would be selected. In an example, the user may be provided with a menu of alternative text segments that is sorted in order of length. In this example, the menu of alternative text segments may “pop up” or “drop down” for viewing and selection by the user. Alternatively, the user may be presented with alternative text segments that are displayed in some other manner that helps the user to consider the relative lengths of the alternative text segments when selecting the second text segment from among them.

In an example, the selection of the second text segment may be done in an automated manner that is at least partially based on text segment length. This could be as simple as having a computer select the shortest alternative text segment when the user wants to decrease the length of the body of text or having a computer select the longest alternative text segment when the user wants to increase the length of the body of text. More complicated automated methods may also be created that consider text segment grammar, word frequency, style, content, or other factors in addition to text segment length when automatically selecting the second text segment.

The last step in this embodiment of the method, step 104, is the substitution of the selected second text segment for the selected first text segment in the body of text. Once all four steps have been completed, this four-step method may be repeated manually or automatically. This method may be employed repeatedly for the same body of text in order to incrementally decrease or increase the length of the body of text as desired by the user. As mentioned above, the user may have the option of allowing “second-order substitution,” especially when multiple or iterative cycles of the method are performed on a body of text. In an example of an automated application of this method, this method may operate in successive iterations until certain criteria (such as an absolute length of the body of text or a desired percentage change in length of the body of text) are achieved.

I claim:

1. A method and system for changing the length of a body of text, comprising:
selection of a first text segment, wherein this first text segment is in a body of text;
automated identification of one or more alternative text segments, wherein each of these alternative text segments may be substituted for the first text segment in the body of text without causing a grammatical error;
selection of a second text segment from among the alternative text segments, wherein the second text segment has a different length than the first text segment; and
substitution of the second text segment for the first text segment in the body of text in order to decrease or increase the length of the body of text.

2. The method and system in claim 1 wherein selection of the first text segment is done using a method selected from the group consisting of: selection of the first text segment by a user; and selection of the first text segment in an automated manner.

3. The method and system in claim 1 wherein the definition of length is selected from one or more metrics in the group consisting of: number of character spaces; number of characters; number of words; number of phrases; number of sentences; number of paragraphs; and number of pages.

4. The method and system in claim 1 wherein: alternative text segments that are shorter than the first text segment are identified in order to decrease the length of the body of text; or alternative text segments that are longer than the first text segment are identified in order to increase the length of the body of text.

5. The method and system in claim 1 wherein the user indicates whether they want to decrease or increase the length of the body of text and wherein alternative text segments that are shorter or longer, respectively, than the first text segment are identified based on this user indication.

6. The method and system in claim 1 wherein: only alternative text segments that do not significantly change the meaning of the body of text when substituted for the first text segment are included in the alternative text segments; or alternative text segments that may change the meaning of the body of text when substituted for the first text segment are included among the alternative text segments.

7. The method and system in claim 1 wherein the user indicates whether they do, or do not, want to allow alternative text segments that may change the meaning of the body of text and wherein identification of alternative text segments complies with this user indication.

8. The method and system in claim 1 wherein identification of alternative text segments is based on one or more methods selected from the group consisting of: using a database comprised of sets of substitutable text segments; using common word patterns or associations observed in a large collection of text-based sources; and using a natural language generator.

9. The method and system in claim 1 wherein identification of alternative text segments: may be done for the first text segment as a whole; or may be done by parsing the first text segment into phrases, identifying possible alternatives for each of the phrases individually, and then combining the alternative phrases into various alternatives for the first text segment as a whole.

10. The method and system in claim 1 wherein “second-order substitution” is substitution within a text segment that is itself already a substitution into the body of text and wherein second-order text segment substitution is, or is not, allowed.

11. The method and system in claim 1 wherein the second text segment is selected by a user from among alternative text segments that are provided to the user, and wherein these alternative text segments are sorted in order of their length or are otherwise provided in a manner that helps the user to consider their relative lengths when making a selection from among them.

12. The method and system in claim 1 wherein the second text segment is selected in an automated manner that is at least partially based on text segment length.

13. A method and system for changing the length of a body of text, comprising:
selection of a first text segment,
wherein this first text segment is in a body of text, and
wherein selection of this first text segment is done by the user or done in an automated manner;
automated identification of one or more alternative text segments:
wherein each of these alternative text segments may be substituted for the first text segment in the body of text without causing a grammatical error;
wherein the lengths of these alternative text segments are defined by one or more metrics selected from the group consisting of: number of character spaces; number of characters; number of words; number of phrases; number of sentences; number of paragraphs; and number of pages;
wherein alternative text segments that are shorter than the first text segment are identified in order to decrease the length of the body of text or wherein alternative text segments that are longer than the first text segment are identified in order to increase the length of the body of text; and
wherein only alternative text segments that do not significantly change the meaning of the body of text when substituted for a first text segment are included in the alternative text segments or wherein alternative text segments that may change the meaning of the body of text when substituted for a first text segment are included among the alternative text segments;
selection of a second text segment from among the alternative text segments:
wherein the second text segment has a different length than the first text segment;
wherein (1) the second text segment is selected by a user from among alternative text segments that are provided to the user, and wherein these alternative text segments are sorted in order of their length or are otherwise provided in a manner that helps the user to consider their relative lengths when making a selection from among them or (2) the second text segment is selected in an automated manner that is at least partially based on text segment length;
and substitution of the second text segment for the first text segment in the body of text in order to decrease or increase the length of the body of text.

14. The method and system in claim 13 wherein the user indicates whether they want to decrease or increase the length of the body of text and wherein alternative text segments that are shorter or longer, respectively, than the first text segment are identified based on this user indication.

15. The method and system in claim 13 wherein the user indicates whether they do, or do not, want to allow alternative text segments that may change the meaning of the body of text and wherein identification of alternative text segments complies with this user indication.

16. The method and system in claim 13 wherein identification of alternative text segments is based on one or more methods selected from the group consisting of: using a database comprised of sets of substitutable text segments; using common word patterns or associations observed in a large collection of text-based sources; and using a natural language generator.

17. The method and system in claim 13 wherein identification of alternative text segments: may be done for the first text segment as a whole; or may be done by parsing the first text segment into phrases, identifying possible alternatives for each of the phrases individually, and then combining the alternative phrases into various alternatives for the first text segment as a whole.

18. The method and system in claim 13 wherein “second-order substitution” is substitution within a text segment that is itself already a substitution into the body of text and wherein second-order text segment substitution is, or is not, allowed.

19. A method and system for changing the length of a body of text, comprising:
selection of a first text segment,
wherein this first text segment is in a body of text, and
wherein selection of this first text segment is done by the user or done in an automated manner;
automated identification of one or more alternative text segments:
wherein each of these alternative text segments may be substituted for the first text segment in the body of text without causing a grammatical error;
wherein the lengths of these alternative text segments are defined by one or more metrics selected from the group consisting of: number of character spaces; number of characters; number of words; number of phrases; number of sentences; number of paragraphs; and number of pages;
wherein alternative text segments that are shorter than the first text segment are identified in order to decrease the length of the body of text or wherein alternative text segments that are longer than the first text segment are identified in order to increase the length of the body of text;
wherein only alternative text segments that do not significantly change the meaning of the body of text when substituted for a first text segment are included in the alternative text segments or wherein alternative text segments that may change the meaning of the body of text when substituted for a first text segment are included among the alternative text segments; and
wherein identification of alternative text segments is based on one or more methods selected from the group consisting of: using a database comprised of sets of substitutable text segments; using common word patterns or associations observed in a large collection of text-based sources; and using a natural language generator;
selection of a second text segment from among the alternative text segments:
wherein the second text segment has a different length than the first text segment;
wherein (1) the second text segment is selected by a user from among alternative text segments that are provided to the user, and wherein these alternative text segments are sorted in order of their length or are otherwise provided in a manner that helps the user to consider their relative lengths when making a selection from among them or (2) the second text segment is selected in an automated manner that is at least partially based on text segment length; and
substitution of the second text segment for the first text segment in the body of text in order to decrease or increase the length of the body of text.

20. The method and system in claim 19 wherein identification of alternative text segments: may be done for the first text segment as a whole; or may be done by parsing the first text segment into phrases, identifying possible alternatives for each of the phrases individually, and then combining the alternative phrases into various alternatives for the first text segment as a whole.
